(19) United States
(12) Patent Application Publication
(10) Pub. No.: US 2022/0281389 A1
(43) Pub. Date: Sep. 8, 2022

(54) TOOL AND CARGO BAG AND TAILGATE ATTACHMENT SYSTEM AND METHOD

(71) Applicant: Aaron Michael Leskosek, Summerland (CA)

(72) Inventor: Aaron Michael Leskosek, Summerland (CA)

(21) Appl. No.: 17/684,943

(22) Filed: Mar. 2, 2022

Related U.S. Application Data
(60) Provisional application No. 63/156,131, filed on Mar. 3, 2021.

(51) Int. Cl. B60R 9/06; B62D 33/023; B60R 11/06; B62D 33/04

(52) U.S. Cl. CPC B60R 9/06; B62D 33/023; B60R 11/06; B62D 33/04

(57) ABSTRACT

A tool bag and attachment system for securing the bag to a tailgate of a truck comprises a tool bag having a compartment accessible through a front closure proximate a front surface of the tool bag, a rear closure on a rear surface of the tool bag, and an attachment hinge comprising an elongate body having a tool bag end, a tailgate end and a flexible portion between the tailgate end and the tool bag end. The tool bag end is secured to an upper peripheral edge of the tool bag and the tailgate end is fastenable to the interior face of the tailgate. When the tailgate end of the attachment hinge is fastened to the interior face of the tailgate, the tool bag rests against either the exterior or interior face of the tailgate by rotating the tool bag about the flexible portion of the hinge.

### CROSS-REFERENCE TO RELATED APPLICATION

This application claims the benefit of U.S. Provisional patent application No. 63/156,131 filed on Mar. 3, 2021 and entitled “Tool and Cargo Bag and Tailgate Attachment System and Method,” which is incorporated herein by reference.

### TECHNICAL FIELD

The present disclosure relates generally to boxes, bags, containers and the like for organizing tools in a vehicle; in particular, the present disclosure relates to tool bags attached to the tailgate of a truck.

### BACKGROUND

Contractors, construction workers and tradesmen who need to transport tools from worksite to worksite will often transport such tools in a pickup truck or similar vehicle having a tailgate. When such workers have a large number of tools that they need to transport and then use at various worksites, it is often a challenge to efficiently organize the tools so that they are readily accessible at the worksite.

Over the years, various solutions have been developed for organizing tools transported in trucks. One solution is to organize the tools in a manually transportable toolbox or tool bag. However, if there are a large number of tools or if the tools are very heavy, it may not be convenient or practical to fit all of the tools within a single toolbox or tool bag or to manually carry the toolbox or tool bag away from the truck and to the worksite. On the other hand, if the toolbox or tool bag is so large that it is not easy to carry around by hand, the worker may choose to leave the toolbox or tool bag inside the truck cab. However, it can be inconvenient to repeatedly go inside the cab of the truck in order to access the toolbox or bag. Furthermore, having to repeatedly enter the cab of a truck while at a worksite is inefficient and can waste precious time.

Another common solution is to mount a tool or utility box inside the bed of a pickup truck. Some examples of tool or utility boxes for pickup trucks include those disclosed in U.S. Pat. No. 4,488,669A issued to Waters, U.S. Pat. No. 5,419,476 issued to White and United States patent publication number US 2005/0121931 applied for by Waye. While such tool or utility boxes for pickup truck beds may provide easier access to the tools, as compared to storing them inside the cab of the pickup truck, because the tool or utility box is typically mounted at the front of the truck bed and adjacent to the cab of the truck, it is often necessary to climb into the truck bed in order to access the tools inside the tool or utility box. If a worker needs to access the tool or utility box numerous times while at a worksite, this may involve climbing into and out of the truck bed many times, which is also inconvenient and can be time-consuming.

Some trucks or sports utility vehicles have a tailgate with a hinge mounted to one of the side rails of the truck bed, so that the tailgate opens to the side, rather than being hinged at the floor of the truck bed so that it opens downwardly (which is the typical configuration of pickup trucks). The applicant is aware of storage organizers manufactured for the use on side-mounted tailgates, such as the “Voodonala for Jeep tailgate toolkit storage bag organizer racks for 2007 to 2018 Jeep wranglers,” advertised for sale on Amazon.com. The Voodonala “organizer rack” comprises a sheet of canvas material that is fastened permanently to an interior face of the side-mounted tailgates, using bolts, screws or similar fasteners, and also includes a system of hooks on the surface of the canvas sheet for attaching small tool bags to the canvas sheet. While such a system allows access to tools and other equipment when the tailgate is open, the tool bag is difficult or impossible to access when the tailgate is closed.

### SUMMARY

In one aspect of the present disclosure, the tool and cargo bag and tailgate attachment system comprises an attachment hinge and a tool or cargo bag for holding and organizing tools and/or other types of cargo. The attachment hinge has an elongated body, with one end adapted for temporarily or permanently fastening the attachment hinge to the tailgate of a truck or vehicle, and the opposite end of the attachment hinge is attached to the tool bag. Between the tailgate end and the tool bag end of the attachment hinge, there is a flexible portion. When in use, the flexible portion of the attachment hinge folds over the upper edge of the tailgate, allowing the tool bag to rest against the exterior face of the tailgate, thereby enabling ease of access to the tool bag from the exterior of the truck when the tailgate is closed. Prior to driving the truck, in order to shelter the tool bag from the elements of the road and surrounding environment, the tool bag may be rotated about the flexible portion of the attachment hinge so as to position the tool bag inside the bed of the truck where it is positioned against the tailgate end of the hinge and adjacent the interior face of the tailgate. Additionally, the tool bag may be obscured from sight by flipping the tool bag about the attachment hinge so as to position the tool bag inside the truck bed when the vehicle is unattended, so as to keep the tool bag out of sight. The tool bag may even be secured inside the truck bed to prevent unauthorized access, for example where the truck bed is fitted with the topper having a locking door.

Advantageously, the tool bag may also be accessible when the tailgate is open. For example, for a tailgate that opens downwardly so that it is in a horizontal position and approximately parallel to the ground underneath the truck, the tool bag may be rotated about the flexible portion of the attachment hinge so as to rest on top of the tailgate, adjacent the interior face of the tailgate, when the tailgate is open. As well, for side-mounted tailgates, the tool bag may be flipped about the tailgate in either direction so as to be accessible from either side of the open tailgate.

In one aspect of the present disclosure, a tool bag and attachment system for securing the tool bag to a tailgate of a truck is provided. The system includes a tool bag has a compartment accessible through a front closure proximate a front surface of the tool bag and a rear closure on a rear surface of the tool bag. The system also includes an attachment hinge having an elongate body with a tool bag end, a tailgate end distal from the tool bag end, and a flexible portion between the tailgate end and the tool bag end. The tool bag end of the hinge is secured to the tool bag at an upper peripheral edge of the tool bag, and the tailgate end is fastenable to the interior face of the tailgate using a fastener. When the tailgate end of the attachment hinge is fastened to the interior face of the tailgate, the tool bag rests against either the exterior or interior face of the tailgate when the tailgate is in a vertical position relative to the ground underneath the truck by rotating the tool bag about the flexible portion of the hinge, and the tool bag may be rotated about the flexible portion of the hinge so as to support the front surface of the tool bag adjacent the interior face of the tailgate when the tailgate is in a horizontal position relative to the ground.

In another aspect of the present disclosure, a method of using the tool and cargo bag and attachment system comprises the steps of: fastening the tailgate end of the attachment hinge to the interior face of the tailgate; rotating the tool bag about the flexible portion of the attachment hinge so as to position the rear surface of the tool bag against the exterior face of the tailgate when the tailgate is in the vertical position so as to enable access to the tool bag compartment through the front closure; and rotating the tool bag about the flexible portion of the attachment hinge so as to position the front surface of the tool bag against the interior surface of the tailgate when the tailgate is in the vertical position so as to secure the tool bag inside a truck box of the truck when the tool bag is not in use. The method may also include the steps of: opening the tailgate so that the tailgate is in the horizontal position; and rotating the tool bag about the flexible portion of the attachment hinge so as to position the front surface of the tool bag against the interior surface of the tailgate when the tailgate is in the horizontal position so as to enable access to the tool bag compartment through the rear closure.

In another aspect of the present disclosure, a tool and cargo bag and attachment system for supporting the tool bag on a tailgate of a truck. The system includes a tool bag having a compartment accessible through a front closure proximate a front surface of the tool bag, and an attachment hook comprising a tool bag end, a tailgate end distal from the tool bag end, and a hook portion between the tailgate end and the tool bag end, wherein the tool bag end is secured to the tool bag at an upper peripheral edge of the tool bag, and the hook is positioned over an upper edge of the tailgate so as to suspend the tool bag from the tailgate.

### BRIEF DESCRIPTION OF THE DRAWINGS

FIG. 1A is a photograph of a pickup truck with the tailgate closed.

FIG. 1B is a photograph of a pickup truck with the tailgate open.

FIG. 1C is a photograph of a pickup truck having a side mounted tailgate that is partially open.

FIG. 1D is a photograph of a pickup truck having a truck topper covering the truck bed, and the tailgate of the truck is closed.

FIG. 2 is a front perspective view of an embodiment of the tool and cargo bag and tailgate attachment system, showing the toolbox in a closed position.

FIG. 3 is a front perspective view of the embodiment of the tool and cargo bag and tailgate attachment system illustrated in FIG. 2, showing the toolbox in an open position.

FIG. 4 is a side perspective view of the embodiment of the tool and cargo bag and tailgate attachment system illustrated in FIG. 2, showing the toolbox in a closed position.

FIG. 5 is a rear perspective view of the embodiment of the tool and cargo bag and tailgate attachment system illustrated in FIG. 2, showing the toolbox in a closed position and rotated about the flexible portion of the attachment hinge so that the rear surface of the toolbox is exposed.

FIG. 6 is a side perspective view of an embodiment of the tool and cargo bag and tailgate attachment system, showing an example of a releasable fastener on the attachment hinge.

FIG. 7 is a side perspective view of an embodiment of the tool and cargo bag and tailgate attachment system, showing an example of a permanent fastener on the attachment hinge.

FIG. 8 is a front perspective view of an embodiment of the tool and cargo bag and tailgate attachment system, wherein the system includes two tool bags.

FIG. 9 is a side perspective view of an embodiment of the tool and cargo bag and tailgate attachment system, wherein the system includes an attachment hook.

### DETAILED DESCRIPTION

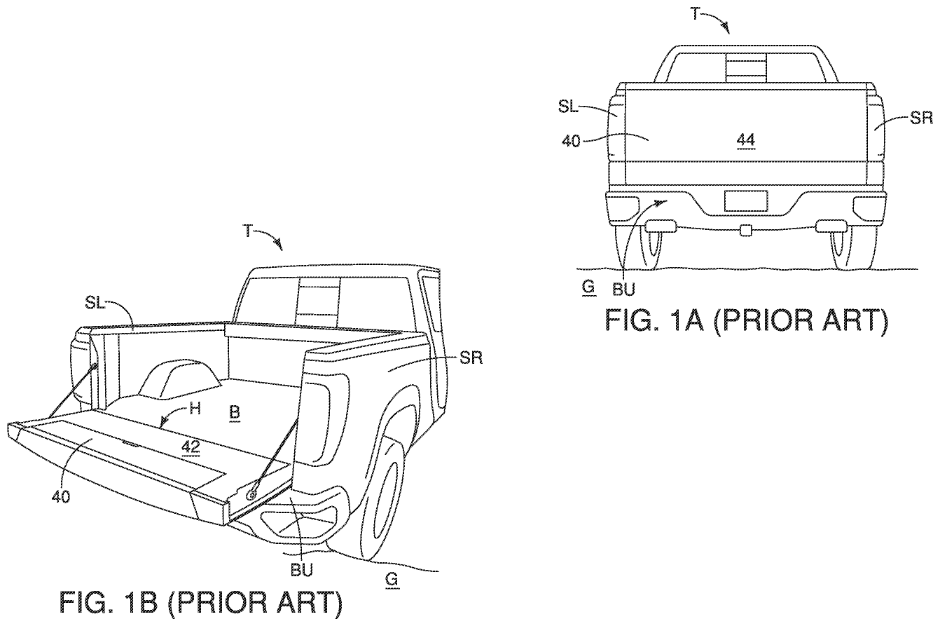

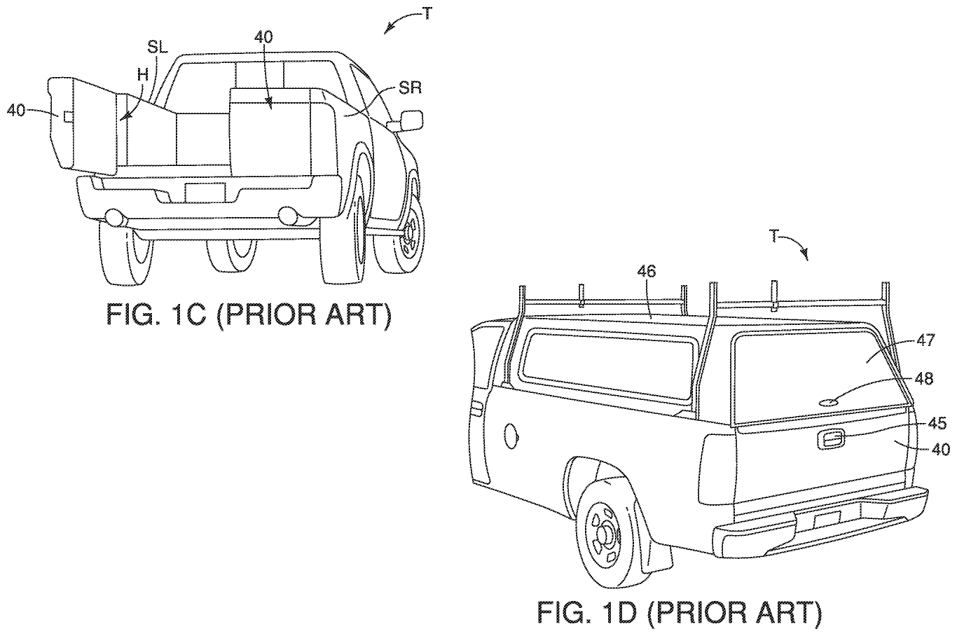

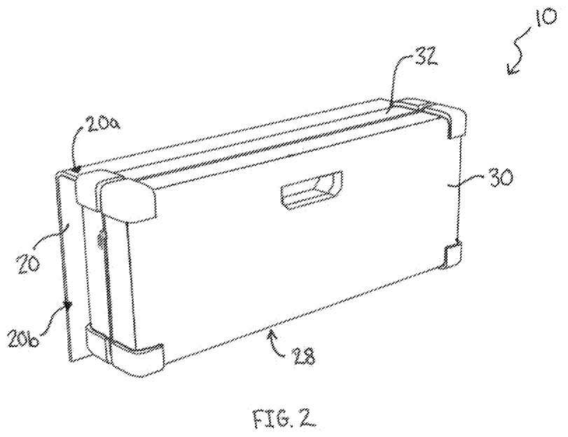

With reference to FIGS. 1A to 9, the tool and cargo bag and tailgate attachment system will now be described. It will be appreciated by a person skilled in the art that, although the present disclosure frequently refers to a “tool bag”, the objects that may be carried in the bag are not limited to tools, and may include for example other types of cargo that may be organized and carried in the bag described herein, such as camping or hunting equipment, sporting equipment, gardening equipment, or any other type of equipment or cargo that a person wishes to transport in a truck and have ready access to the equipment or cargo near the tailgate of the truck when the truck is stationary. It will also be appreciated that the tool or cargo “bag” of the present disclosure is not meant to be limited to a bag manufactured of a flexible material, and is also intended to include other types of cases or containers for organizing and transporting tools or other types of cargo, and that such cases or containers may be partially or entirely constructed of flexible, stiff or hard materials, all of which is included in the scope of the present disclosure.

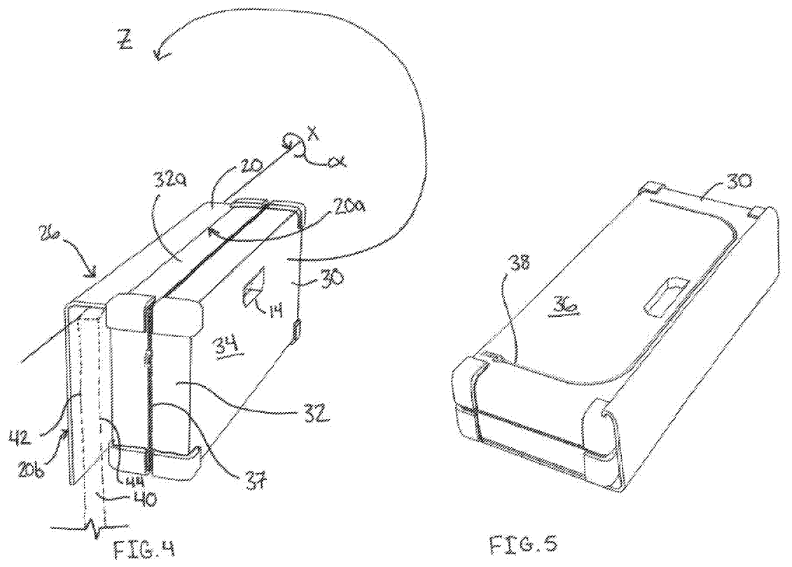

As best viewed in FIGS. 2 and 4, the tool bag and tailgate attachment system 10 includes a tool bag, case, box or like container 30 that is attached to the tailgate attachment hinge 20. The tool bag may be made of a durable, flexible material, and may have a rigid exterior shell in some embodiments. In other embodiments, portions of the exterior of the tool bag may be reinforced, such as the corners may be provided with metal or rubber caps, so as to increase the durability of the tool bag. The tool bag 30, in some embodiments, is permanently attached to the hinge 20 at an upper peripheral edge 32a of the toolbox 30. The hinge 20 is attached to the tool bag 30 at a tool bag end 20a of the hinge, while the tailgate end 20b of the hinge is either permanently or removably attached to the tailgate 40 of the pickup truck. The attachment hinge 20 is attached to the toolbox 30 by means known to a person skilled in the art, including but not limited to, for example, adhesive, bolts, rivets or other fasteners, thermoplastic moulding, stitching and the like.

FIGS. 1A through 1D show examples of pickup trucks with tailgates, as are known in the prior art. A truck typically has a tailgate 40 that provides rear access to the bed B of the truck T. The truck bed B is bounded by left and right side rails SL, SR. In typical pickup truck configurations, the tailgate 40 may have a hinge that is adjacent the bed B and the bumper BU of the truck T. In this typical configuration of a pickup truck, as shown in FIG. 1A, when the tailgate 40 is in a closed position the tailgate 40 is in a vertical position with respect to the ground G, whereas, as shown in FIG. 1B, when the tailgate is open, the tailgate is substantially horizontal and substantially parallel to the ground G. By substantially, it will be appreciated herein that the tailgate 40 may not be in a precisely horizontal or vertical position, or it may not be precisely parallel to the ground; for example, the tailgate might be sloped upwardly or downwardly by a few degrees relative to the ground G.

Furthermore, the tailgate 40 has two faces; namely, an interior face 42, which forms an interior wall of the truck bed B when the tailgate is closed, and an exterior face 44, which face is disposed outwardly of the truck bed and forms an exterior surface of the truck T when the tailgate is closed. As shown in FIG. 1C, it will also be appreciated that the tailgate 40 may have a hinge that is mounted to one or both of the side rails SR, SL; for example, in FIG. 1C, it can be seen that the tailgate 40 is divided into two parts, with one hinge attached to the left side rail SL, and the other hinge attached to the right side rail SR. Other trucks or vehicles (not shown) may have a side-mounted tailgate that is attached by a hinge to only one of the two side rails SR, SL.

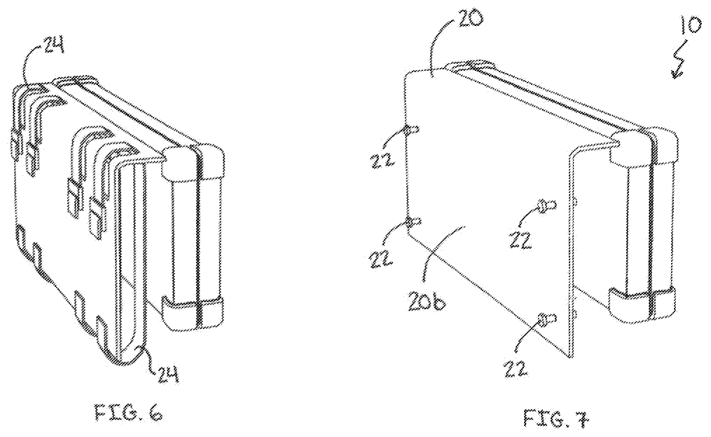

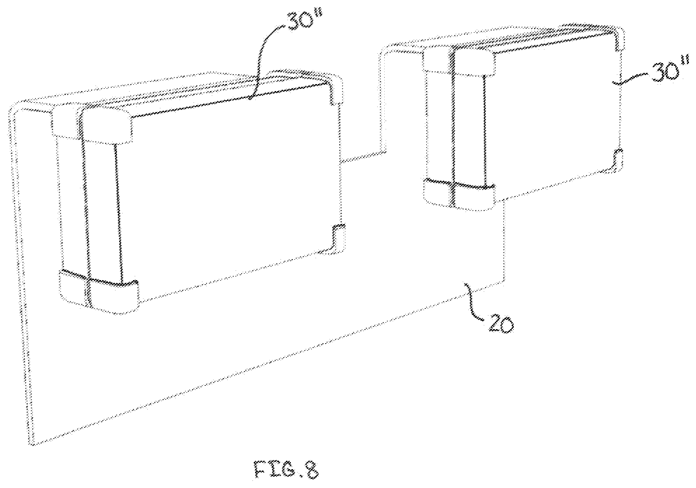

As best viewed in FIG. 4, the attachment hinge 20 is mounted to the tailgate 40 by fastening the tailgate end 20b of the attachment hinge 20 to an interior face 42 of the tailgate 40. Attachment is accomplished by using permanent or releasable fasteners as are known to a person skilled in the art. For example, not intending to be limiting, permanent fasteners 22 may include, but are not limited to, bolts, screws, adhesive and the like, such as shown for example in FIG. 7. Releasable fasteners 24, on the other hand, may be used when it is desired to temporarily mount the toolbox to the tailgate of a truck or vehicle. Such releasable fasteners include, but are not limited to, straps with buckles, straps with hook and loop fasteners, elastic cords with hooks, fastening straps, and magnets. An example of releasable fasteners 24, comprising straps with buckles, is illustrated in FIG. 6.

The attachment hinge 20 as an elongate body, with the tool bag end 20a attached to tool bag 30, and the opposite tailgate end 20b attached to the tailgate. The tool bag end 20a of the hinge 20 is secured to the tool bag 30 using methods known to a person skilled in the art. For example, the hinge 20 may be attached to the tool bag 30, at an upper peripheral edge 32a, by means including but not limited to: stitching, rivets, bolts or other fasteners, heat moulding, or any other suitable for attaching attachment hinge 22 the tool bags 30. In some embodiments, the hinge 20 may be formed integrally with a portion of the tool bag 30. The attachment hinge also includes a flexible portion 26 between the tool bag end 20a and the tailgate end 20b, where the hinging occurs. For example, at least the flexible portion 26 of the hinge 20 may be made of a durable, strong, flexible material capable of supporting the weight of the tool bag 30 and the tools stored within, such materials including but not limited to rubber, canvas, reinforced fabric, etc. It will be appreciated by person skilled in the art that a flexible material hinge is not the only type of hinge that may constitute the flexible portion 26 of the attachment hinge 20, and that other types of hinges, including but not limited to metallic hinges, may be used which are capable of enabling rotation of the tool bag 30 in the range of approximately 360° about hinge axis X and through rotational angle a, such that the toolbox 30 is able to flip onto either side 42, 44 of the tailgate 40. The hinge 20 enables the toolbox 30 to be positioned against the exterior face 44 of the tailgate 40, or else stored inside the bed B of the pickup truck T by rotating the toolbox through rotational angle a, which is approximately 360° , in direction Z, such that the front surface 34 is positioned against the tailgate end 20b of the attachment hinge 20 and adjacent to the inter-interior surface 42 of the tailgate 40.

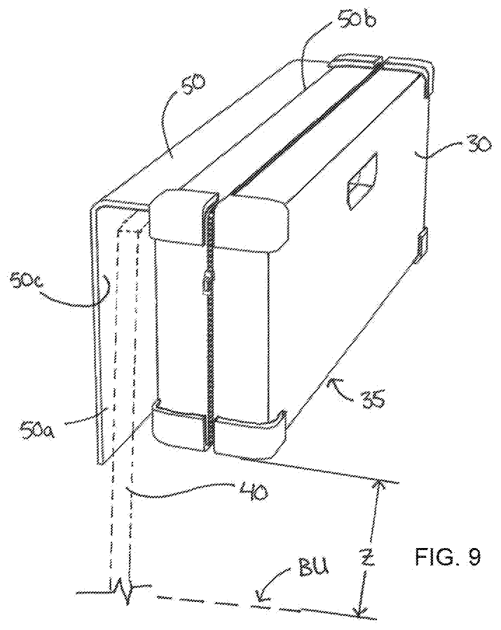

In some embodiments, such as illustrated in FIG. 9, rather than an attachment hinge 20, the system may be provided with an attachment hook 50, which attachment hook 50 is rigid and does not include a flexible portion between a first end 50a and a second end 50b of the attachment hook 50. Advantageously, the rigid attachment hook 50 is simply placed over the tailgate 40 when the tailgate is in a vertical position, allowing access to the tool bag 30 from outside the truck. In such embodiments, the attachment hook may or may not be attached to the tailgate. If the attachment hook is attached to the tailgate, using either permanent or releasable fasteners, the lower peripheral edge 35 of the tool bag 30 may be positioned at a height Z above the bumper BU of the truck, so as to allow sufficient clearance for the tail gate 40 to be fully opened such that it is substantially horizontal relative to the ground G. On the other hand, if the attachment hook is not permanently or releasably attached to the tailgate 40, the user may simply lift the attachment hook 50 off of the tailgate when it is desired to secure the tool bag 30 inside the truck, or to remove the tool bag 30 entirely from the truck. The attachment hook 50 may be manufactured of a rigid, durable material, including but not limited to metal, plastic, composites and other suitable materials known to a person skilled in the art. Additionally, the inner surface 50c of the attachment hook 50 may be provided with a soft lining material, including but not limited to cloth, leather or rubber, so as to protect the tailgate 40 from scratches or damage during use.

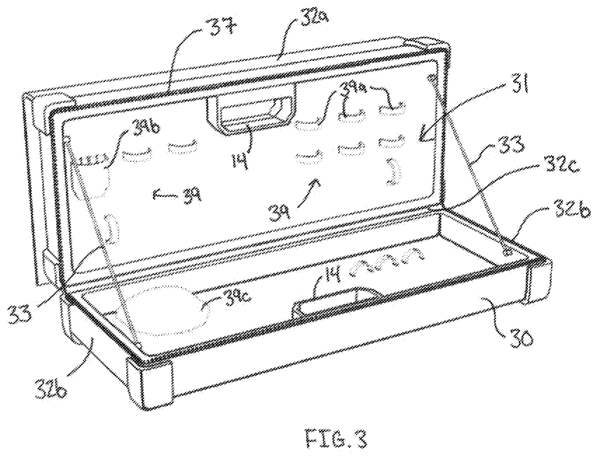

Returning to the embodiments illustrated in FIGS. 2 to 8, wherein the system includes an attachment hinge 20, in one aspect the toolbox 30 may be laid in a substantially horizontal position on top of the interior surface 42 of the tailgate 40 when the tailgate 40 is in a substantially horizontal position, such as shown in FIG. 18. In such a configuration, such as shown in FIG. 5, the rear surface 36 of the tool bag 30 is exposed when the tool bag 30 rests on top of the tailgate 40. Conveniently, the rear surface 36 of the tool bag 30 may be provided with a rear opening 38 for access to the cavity of the tool bag 30, the rear opening 38 secured closed by means known to a person skilled in the art, such as a zipper 38 as shown in FIG. 5, although other types of closing fasteners for securing closed the openings of tool bags are considered to fall within the scope of the present disclosure, such as for example snaps, buttons, latches, buckles, straps, clips and the like. Additionally, in some embodiments, the front closure37 may, in some cases, include a zipper 37 runs around the peripheral edge 32 of the tool bag 30, where the tool bag 30 is configured as two halves that are zipped together with zipper 37 when closed, and attached only along the bottom edge 28 when the front closure 37 is open. Conveniently, in some embodiments of the tool bag 30 as shown in FIG. 3, the front zipper 37 runs around the peripheral side edges 32a, 32b, so as to enable access to the cavity 31 through a wide opening, enabling ease of access to the contents within the tool bag 30. The two halves of the tool bag 30 may be attached along the bottom peripheral edge 32c by a flexible material of the tool bag 30 to thereby form a hinge 32c; although it will be appreciated that hinge 32c may also be constructed of other materials, such as for example a metallic hinge 32c may be used to attach the two halves of a hard-shelled tool bag or case 30.

In some embodiments, such as shown in FIG. 3, the tool bag 30 may include a set of braces 33 for supporting the case 30 in an open position. The braces 33 would be of a construction known to a person skilled in the art; for example, not intending to be limiting, the braces may be telescoping, or they may be provided with pivot in between the two ends of each brace. In some embodiments, the interior of the tool bag 30 may be provided with a plurality of organizing elements 39, which includes but are not limited to elastic loops 39a, pockets 39b, containers 39c, clips, hooks and the like. The organizing elements 39 assist with keeping the tools organized and in place within the tool bag during transport.

Conveniently, in some embodiments the case 30 includes a handle aperture 14 as may be viewed in FIG. 4. The handle aperture 14 may be sized and positioned so as to align with a tailgate handle 45 located on the exterior surface 44 of the tailgate. The aperture 14 passes through the front surface 34 and the rear surface 36 of the tool bag 30, such as may be shown in FIG. 3. Thereby, a user of the tool bag 30 may insert their hand through the handle aperture 14 in order to access and manipulate the tailgate handle 45 when it is desired to open the tailgate 40 when the tool bag 30 is mounted to the tailgate 40 and positioned against the exterior surface 44 of the tailgate.

As discussed throughout, the tool bag and tailgate attachment system 10 disclosed herein advantageously rotates about the rotational axis X of attachment hinge 20 so as to enable ease of access to the tool bag 30 from the exterior of the truck, and also to enable ease of access to the tool bag 30 when tailgate is open, as the tool bag is rotatable about axis X so as to rest against the interior surface 42 of the open tailgate when the tailgate 40 is in an open, horizontal position. A further advantage, when the system 10 is installed on a pickup truck having a truck topper a secured truck topper 46, is that in order to secure the tool bag for example when the vehicle is parked and the owner is away from the vehicle, the tool bag 30 may be conveniently secured inside the truck bed B by rotating the tool bag 30 about axis X so that the tool bag 30 is adjacent the interior surface 42 of the tailgate 40. Additionally, if the topper 46 includes a topper door 47 that is secured, for example with a lock 48, then the tool bag may be completely secured within the truck bed so as to discourage or prevent theft of the tools. An example of a typical truck topper 46 on truck T is shown for example in FIG. 1D.

It will be appreciated by persons skilled in the art that the disclosure herein is not limited to a single tool bag 30 mounted to an attachment hinge 20. For example, without intending to be limiting, FIG. 8 illustrates an embodiment where there are two tool bags 30′, 30″ attached to a single attachment hinge 20. Such a configuration may be desirable, for example, where additional capacity is required.

What is claimed is:

1. A tool and cargo bag and attachment system for securing the tool and cargo bag to a tailgate of a truck, the tailgate having an exterior face and an interior face, the system comprising:
a tool bag having a compartment, the compartment accessible through a front closure proximate a front surface of the tool bag and a rear closure on a rear surface of the tool bag,
an attachment hinge comprising an elongate body having a tool bag end, a tailgate end distal from the tool bag end, and a flexible portion between the tailgate end and the tool bag end, wherein the tool bag end is secured to the tool bag at an upper peripheral edge of the tool bag, and the tailgate end is fastenable to the interior face of the tailgate using a fastener,
wherein, when the tailgate end of the attachment hinge is fastened to the interior face of the tailgate the tool bag rests against either the exterior or interior face of the tailgate when the tailgate is in a vertical position relative to a ground underneath the truck by rotating the tool bag about the flexible portion of the hinge, and the tool bag may be rotated about the flexible portion of the hinge so as to support the front surface of the tool bag adjacent the interior face of the tailgate when the tailgate is in a horizontal position relative to the ground.

2. The system of claim 1, wherein the fastener is a releasable fastener for releasably fastening the attachment hinge to the tailgate.

3. The system of claim 2, wherein the said releasable fastener is selected from a group comprising:
one or more fastening straps, one or more fastening buckles, one or more elastic cords with hooks, one or more magnets.

4. The system of claim 1, wherein the said fastener is a permanent fastener for permanently fastening the attachment hinge to the tailgate.

5. The system of claim 4, wherein the permanent fastener is selected from a group comprising: bolts, screws, adhesive.

6. The system of claim 1, wherein the tailgate end of the attachment hinge is integrally formed with the interior face of the tailgate.

7. The system of claim 1, wherein the front closure comprises a zipper disposed around a peripheral edge of the tool bag, the peripheral edge including the upper peripheral edge and located between the front and rear surfaces of the tool bag.

8. The system of claim 7, wherein the tool bag further comprises a bracket, the bracket operable to support a front portion of the tool bag in a horizontal position substantially parallel to the ground when the front closure of the tool bag is open and the tailgate is in the vertical position.

9. The system of claim 1, wherein the tool bag secured to the tool bag end of the attachment hinge comprises two or more tool bags secured to the tool bag end of the attachment hinge.

10. The system of claim 1, wherein the tool bag comprises a handle aperture extending through the front and rear surfaces of the tool bag, and wherein when the system is attached to the tailgate and the tailgate is in the vertical position with the tool bag resting against the exterior face of the tailgate, a tailgate handle of the tailgate is accessible through the handle aperture of the tool bag.

11. The system of claim 1, wherein the rear closure comprises a zipper disposed on the rear surface of the tool bag so as to access the tool bag compartment when the tool bag is resting on its front surface.

12. The system of claim 1, wherein the compartment of the tool bag further comprises one or more organizing elements.

13. The system of claim 12, wherein the one or more organizing elements are selected from a group comprising: straps, hook-and-loop straps, elastic loops, hooks, cups, containers, interior compartments, reinforced eyelets.

14. A method of using the system of claim 1, comprising:
fastening the tailgate end of the attachment hinge to the interior face of the tailgate;
rotating the tool bag about the flexible portion of the attachment hinge so as to position the rear surface of the tool bag against the exterior face of the tailgate when the tailgate is in the vertical position so as to enable access to the tool bag compartment through the front closure;
rotating the tool bag about the flexible portion of the attachment hinge so as to position the front surface of the tool bag against the interior surface of the tailgate when the tailgate is in the vertical position so as to secure the tool bag inside a truck box of the truck when the tool bag is not in use.

15. The method of claim 14, further comprising the steps of:
opening the tailgate so that the tailgate is in the horizontal position;
rotating the tool bag about the flexible portion of the attachment hinge so as to position the front surface of the tool bag against the interior surface of the tailgate when the tailgate is in the horizontal position so as to enable access to the tool bag compartment through the rear closure.

16. A tool and cargo bag and attachment system for supporting the tool bag on a tailgate of a truck, the tailgate having an exterior face and an interior face, the system comprising:
a tool bag having a compartment, the compartment accessible through a front closure proximate a front surface of the tool bag,
an attachment hook comprising a tool bag end, a tailgate end distal from the tool bag end, and a hook portion between the tailgate end and the tool bag end, wherein the tool bag end is secured to the tool bag at an upper peripheral edge of the tool bag, and the hook is positioned over an upper edge of the tailgate so as to suspend the tool bag from the tailgate.
